(19) United States
(12) Patent Application Publication
(10) Pub. No.: US 2020/0250425 A1
(43) Pub. Date: Aug. 6, 2020

(54) Intelligent Color Observation System to Sustain Ideal Crop Health

(71) Applicant: Arya Kishan Tschand, Marlboro, NJ (US)

(72) Inventor: Arya Kishan Tschand, Marlboro, NJ (US)

(73) Assignee: Parwan Electronics Corporation, Aberdeen, NJ (US)

(21) Appl. No.: 16/730,499

(22) Filed: Dec. 30, 2019

Related U.S. Application Data
(60) Provisional application No. 62/799,365, filed on Jan. 31, 2019.

(51) Int. Cl. G06K 9/00; G06T 7/90; G06K 9/62; G06K 9/46

(52) U.S. Cl. CPC G06K 9/00657; G06T 7/90; G06K 2209/17; G06K 9/4652; G06K 9/6256

(57) ABSTRACT

The global water crisis has prevented people from across the world from accessing clean and reliable sources of water. The single largest cause of the crisis is our mismanagement of water in agriculture. The present invention solves this issue by implementing an intelligent micro-irrigation management system that maintains crop health. A preliminary set of crops given varying volumes of water daily is grown and based on user feedback, an initial crop irrigation volume and the minimum healthy color threshold is calculated. Each crop is given the initial irrigation volume, but as each crop responds in different ways, the system recognizes changes in health and adjusts the specific irrigation volume after each change in crop health to maintain crops at the color threshold while minimizing water wastage. Based on the collected data, trends are found to more accurately adjust the irrigation volume to give minimum water while maintaining the color threshold.

### FIELD OF THE INVENTION

The present invention relates generally to intelligent crop irrigation. More specifically, the present invention is an agricultural micro-irrigation system utilizing a dynamic linear regression based artificial intelligence algorithm to accurately adjust resource use to maintain crops at a minimum healthy color threshold while minimizing water wastage.

### BACKGROUND

The present invention is an advanced form of precision irrigation. Precision irrigation is a popular form of intelligent irrigation that can discern between intra-field variability and adjust irrigation, pesticide placement, and fertilizer use accordingly. Precision irrigation depends on the collection of data to quantify the needs of crops. Common forms of data points collected by precision systems include color, reflectivity, soil moisture, light, humidity, temperature, nitrogen content, pH, etc. Currently, the primary purpose of implementing precision irrigation and variable rate irrigation systems is to maximize yield return on input and conserve water and nutrient resources.

As is well known and understood, there are varying levels of complexity and intelligence tied to each form of precision irrigation. Newer systems are beginning to implement various forms of artificial intelligence to draw trends from data and maximize efficiency, either with crop yield or resource management. Common forms of artificial intelligence used with precision irrigation are machine learning and neural networks, both of which can analyze and extract trends from the collected data set to improve the system.

As stated before, systems utilizing artificial intelligence require many quantified data points to extract these trends, and because crop color data is tedious and expensive to collect and difficult to quantify, it is not often used. Data points such as temperature, humidity, and soil moisture are among the most common for their relatively low cost, quick collection, and easy quantification. However, a common problem with these commonly used data points is their inability to accurately quantify the health of each crop. While measurements such as temperature, pH, light, humidity, etc. depict the status of the environment surrounding the crops, they are not a direct measurement of crop status and can therefore never truly predict a crops' water and nutrient needs.

Crop color data is widely considered the ideal measurement of crop health for its ability to measure crops' reactions to the environment. Multispectral imagery, which captures images of crops using multiple wavelengths of light, is a form of color data collection where each wavelength conveys unique information about the crop.

However, there are numerous limitations to color data collection, primarily its high cost. The cost associated with expensive multispectral imaging equipment and storing high definition images prevents high volumes of data collection. Of the small percentage that utilizes color input precision irrigation systems, it is primarily used to set a benchmark value for crop irrigation with few to no changes throughout their growth.

Because of the lack of color data usage in high volatility variable rate irrigation systems, artificial intelligence algorithms designed to maximize the accuracy of changes in resource use are non-existent. While the color data utilized is often extremely accurate, unique changes to each crop are necessary to maximize crop yield and quality while minimizing resource wastage. However, current precision irrigation systems utilizing crop color as their primary source of data cannot offer these capabilities.

### BRIEF SUMMARY OF THE INVENTION

The present invention is a controller that continually monitors crop color and uses artificial intelligence to adjust the crop irrigation volume whenever needed. The controller rotates over each crop and uses a visible light camera to continually capture and save images. Computer vision software is used to detect and quantify the color of a crop. All irrigation and color data are stored on a local database for future analysis. Because only visible light images are used, equipment used for data collection is more affordable and therefore capable of more widespread implementation. By saving the quantified analysis of each image instead of each image, far less storage is needed to operate the system. Calculations based on artificial intelligence algorithms utilizing dynamic linear regression extract trends from the data set measuring individual crop reactions to various volumes of water, measured as the average color change per milliliter of water given. Based on user feedback from a preliminary set of crops, the minimum healthy color threshold is calculated and whenever the crop color is significantly different than the color threshold, the specific values calculated from the artificial intelligence algorithms are used to balance the individual irrigation volume to restore the ideal crop health. As the data set grows, the changes become increasingly accurate, minimizing water wastage while maintaining a healthy crop level. Combined with the system's ability to capture, analyze, and store images more efficiently than other systems and the software program's ability to accurately adjust resource usage, the proposed invention offers an affordable, scalable, and efficient method to maximize crop yields while minimizing resource wastage.

### BRIEF DESCRIPTION OF THE DRAWINGS

Some embodiments of the present invention are illustrated as an example and are not limited by the figures of the accompanying drawings, in which like references may indicate similar elements and in which

FIG. 1 is a diagram drawing of the controller assembly. It depicts the materials used to assemble the base and arm of the controller, the precise locations of metal plates, screws, nuts, and bolts, and the stepper motor used to rotate the arm;

FIG. 2 is a diagram drawing of the controller hardware placement. It depicts the locations of the motor driver, peristaltic pump, visible light camera, USB hub, and Arduino-based controller board. The diagram also depicts the USB connection to the external computer and pump tubing connection to the water supply;

FIG. 3 is a flowchart depicting the find healthy HSV function. The function calculates and returns the minimum healthy color threshold based on preliminary data;

FIG. 4a is a flowchart depicting the preliminary data analysis stage of the main program. The initial crop irrigation volume and average color change per milliliter of water given is set in this section for later use in the main program;

FIG. 4b is a flowchart depicting the secondary artificial intelligence stage of the main program. The individual CIV is continually adjusted based on collected color in this section of the main program. This section loops until the crops are fully grown;

FIG. 5 is a flowchart depicting the check plants function, where the color data is collected and analyzed and changes are made to the crop irrigation accordingly;

FIG. 6 is the user interface used to collect feedback from the user regarding the health of the preliminary set of plants. This data is used as a benchmark for the artificial intelligence program. The interface is also used throughout the secondary artificial intelligence stage to show the user the interpreted colors of each plant and current and past individual crop irrigation volumes;

### DETAILED DESCRIPTION OF THE INVENTION

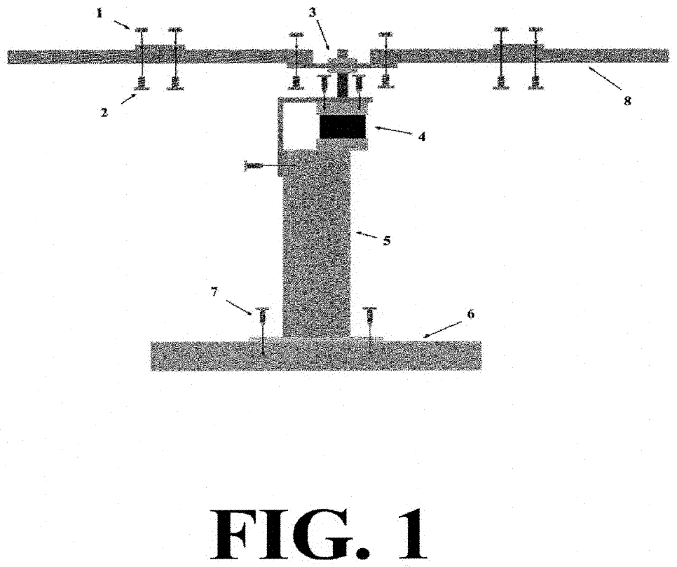

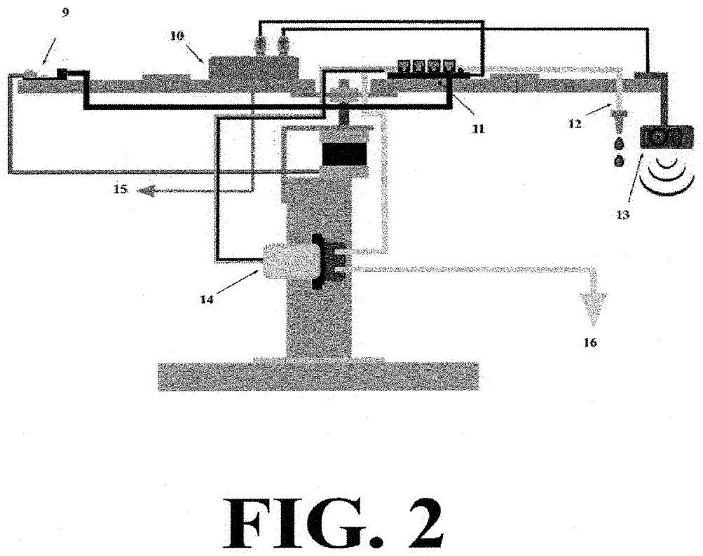

The controller, depicted in FIGS. 1 and 2, includes a robotic arm whose rotation is controlled with a direct current stepper motor 4 to rotate the arm over each crop. The arm is attached to the motor 4 using tightened shaft collars 3. The motor 4 is attached above a wooden stand 5 to allow the arm to rotate above each crop. The entire arm is attached to a broad wooden base 6 with eight mm screws 7 to provide stability to the controller. The stepper motor 4 was used because it has no limitations to rotations, allowing the controller to turn a full three hundred and sixty (360) degrees. Attached to the motor 4 is the arm consisting of two attached metal plates 8 on either side of the motor 4 connected using eight mm nuts 1 and eight mm bolts 2. The arm is attached to the motor 4 using shaft collars 3. At the end of one side of the controller is the visible light camera 13. The camera 13 is connected to a universal serial bus (USB) hub 10 above the motor 4, which is connected to the computer via USB extension 15. Attached to the wooden stand 5 underneath the motor 4 is the peristaltic water pump 14 responsible for watering the crops when the controller rotates over each crop. Because the pump 14 is heavy, it must be located at the center of the controller to reduce torque. The pump 14 has two plastic tubes. One tube is the input and is connected to a water supply 16. The other tube is the output and is connected to the end of the controller 12 near the camera 13. At the other end of the controller is the motor driver 9 responsible for passing instructions from the Arduino Uno based control board 11 to the motor 4. The driver 9 is located here to counteract the torque provided by the camera 13 on the other end of the controller. The control board 11 is located at the center of the arm with the camera 13. The control board 11 is responsible for receiving information via USB from the computer and sending instructions to the motor 4 and pump 14 for rotation and watering.

Multiple times daily, the controller rotates over each crop and captures an image using the visible light camera 13. The image is sent back to the computer via USB extension 15 where the image is analyzed by a computer vision software, executed in lines 309-414 of the VB.net program file in the computer program listing appendix. The software breaks down the image to pixels and uses k-means clustering to pinpoint maximum differences in color within the image. This process is used to discern between pixels that correspond to the crop with pixels that correspond with unimportant objects such as soil or fertilizer. Each pixel corresponding to the crop is quantified via hue, saturation, value (HSV) color scale and the average values among crop pixels are calculated.

The HSV scale is used because the value (V) quantity is an ideal representation of the color depth of the crop. A lesser V equates to a deeper color, which is proven to correspond to a healthier crop. After each image is collected and analyzed, this value is stored in a local database for future analysis. The framework code for the database can be found in lines 1-15 of the mySQL program file in the computer program listing appendix. Based on the artificial intelligence (AI) analysis of prior data and the previously collected data, commands for precise crop irrigation volume (CIV) sent back to the controller via USB and carried out by the peristaltic pump 14.

The most widely used forms of precision irrigation utilize AI to determine the specific CIV, but do not invest nearly as many resources in maintaining an optimal CIV. While these precision irrigation systems are capable of irrigation crops numerous times daily, the specific CIV rarely changes to adjust to crop needs and status. The AI algorithms utilized in the present invention are designed to calculate the ideal CIV based on previous data for the crop and the crop's current color. More specifically, based on previously saved and collected data, the dynamic linear regression algorithm is used to calculate the average color change per milliliter (mL) of water given (ACCpM). This is calculated by mapping the collected data on an XY grid with water given (mL) as the domain and color (V) as the range. The slope of the regression equation is interpreted as the ACCpM. The dynamic linear regression algorithm can be found in lines 159-186 of the Arduino C++ program file in the computer program listing appendix and lines 173-211 of the VB.net program file in the computer program listing appendix. As expected, during testing, a negative ACCpM was always found, indicating a darker crop color after more water was given.

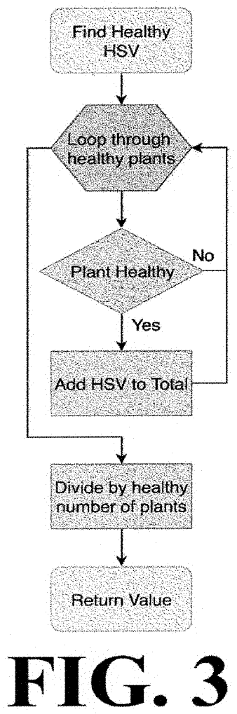

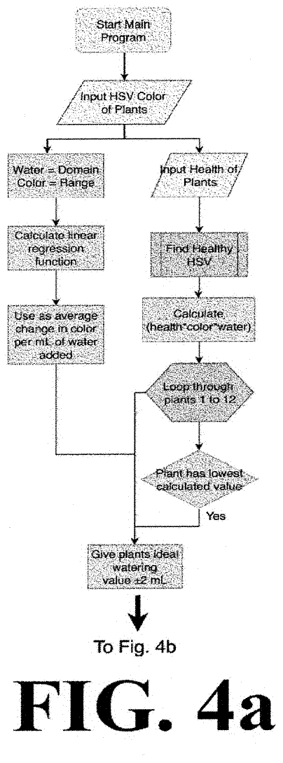

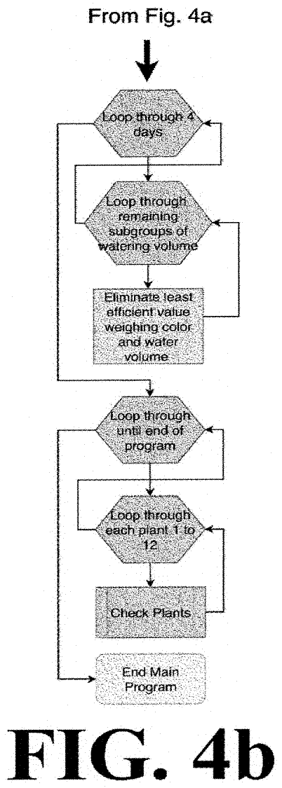

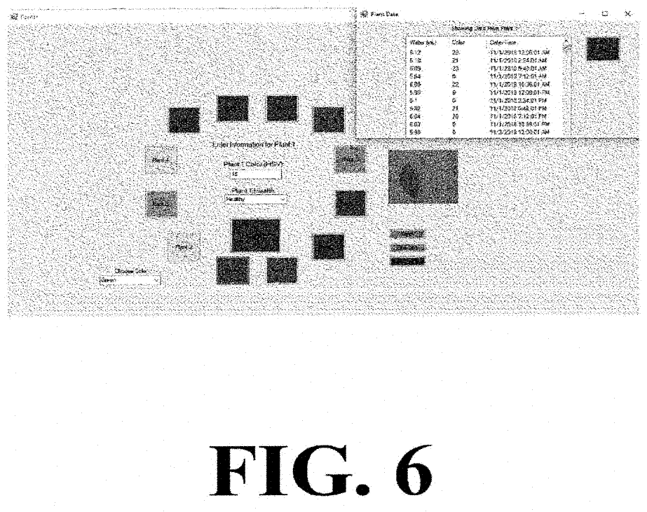

Before the AI is implemented, a preliminary set of crops are grown, executed in lines 481-498 of the Arduino C++ program file in the computer program listing appendix. The purpose of these crops, as depicted in FIG. 4a, is to determine the initial CIV, set a minimum healthy color threshold based on user feedback through a user interface, as depicted in FIG. 6, and calculate a base ACCpM. Because the CIV is very volatile due to the tight micromanagement, the initial CIV, executed in lines 190-214 of the Arduino C++ program file in the computer program listing appendix, heavily favors a lesser water volume over maximum health. User feedback on the subjective health of the crop is mapped to the final color of the crop to determine a color threshold, as depicted in FIG. 3 and executed in lines 137-155 of the Arduino C++ program file in the computer program listing appendix, which is later used to alert the program if a crop's health is below the user's preferences. The dynamic linear regression algorithm is also used to analyze the preliminary data set to extrapolate the base ACCpM, which eventually updates for each crop.

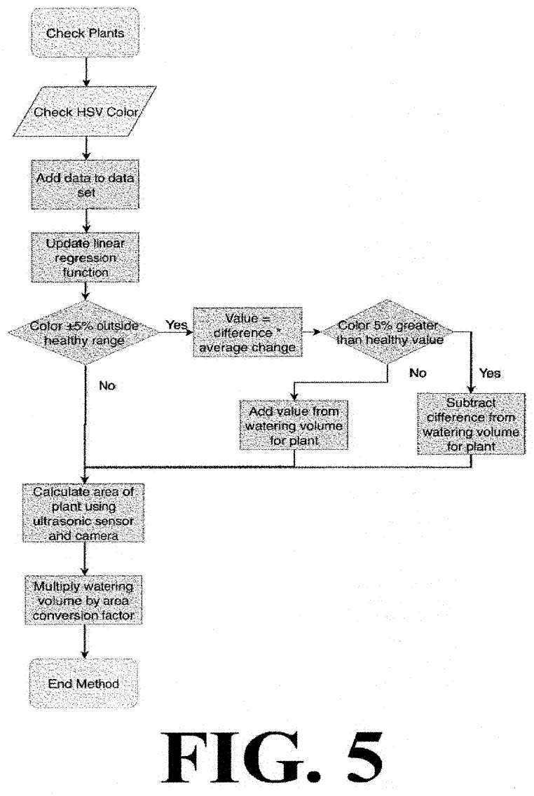

After all initial values are collected, the secondary AI phase can begin, where each crop is micromanaged from the time it sprouts, as depicted in FIG. 4b. The color is collected multiple times daily, executed in lines 234-243 of the Arduino C++ program file in the computer program listing appendix and lines 229-249 of the VB.net program file in the computer program listing appendix, analyzing each image and updating the CIV when necessary, as depicted in FIG. 5 and executed in lines 393-427 of the Arduino C++ program file in the computer program listing appendix. If the color is over five percent less than the color threshold, the crop is considered unhealthy. The crop's CIV is increased based on the ACCpM where the color will ideally return to the color threshold while using the minimal volume of water needed to maintain this level. On the other hand, if the color is over five percent greater than the color threshold, the CIV is reduced accordingly.

Because the color of a crop is relatively volatile, small changes to the CIV can be made multiple times daily. This is ideal because as the data set grows and the ACCpM becomes more accurate, the system is capable of maintaining the minimum healthy color threshold more closely while minimizing water usage to do so. Furthermore, by systematically reducing the color until it reaches the color threshold, any overwatering can be eliminated quickly.

Although the invention has been explained in relation to its preferred embodiment, it is to be understood that many other possible modifications and variations can be made without departing from the spirit and scope of the invention.

What is claimed is:

1. An intelligent irrigation system and software designed to minimize water wastage while maintaining ideal crop health, using continually collected HSV crop color data to update a crop irrigation volume multiple times daily

2. An irrigation controller utilizing the system of said claim 1 for rotation over each crop to capture individual crops color and irrigate crops. The controller comprising:
a. A stepper motor and driver responsible for controller rotation
b. A water pump responsible for irrigating crops
c. A visible light camera responsible for capturing images of crops
d. An Arduino-based control board responsible for instructing motors and sensors
e. A computer with memory responsible for analyzing images and storing data to extract color change trends

3. An artificial intelligence software embedded in the system of said claim 1 to take data from said claim 2 as an input and return an updated crop irrigation volume. The software comprising:
a. Training data of irrigation volume, crop color, and visual health from preliminary crop growth set to determine a subjective minimum healthy color threshold according to user preference
b. Dynamic linear regression algorithm to map irrigation volume as the domain and crop color as the range to extrapolate average color change per milliliter of water given
c. Recognize a significant difference between measured color and minimum healthy color threshold and adjust crop irrigation volume according to average color change per milliliter of water given
